(19) United States
(12) Patent Application Publication
(10) Pub. No.: US 2016/0293394 A1
(43) Pub. Date: Oct. 6, 2016

(54) MALDI-TOF MS Method And Apparatus For Assaying An Analyte In A Bodily Fluid From A Subject

(71) Applicant: Virgin Instruments Corporation, Marlborough, MA (US)

(72) Inventors: Mark W. Duncan, Denver, CO (US); Marvin L. Vestal, Framingham, MA (US); Stephen Hattan, Lowell, MA (US); Kenneth Parker, Hopkinton, MA (US)

(73) Assignee: Virgin Instruments Corporation, Marlborough, MA (US)

(21) Appl. No.: 15/079,900

(22) Filed: Mar. 24, 2016

Related U.S. Application Data
(60) Provisional application No. 62/139,885, filed on Mar. 30, 2015.

(51) Int. Cl. H01J 49/16; H01J 49/00; H01J 49/40

(52) U.S. Cl. CPC H01J 49/164; H01J 49/40; H01J 49/0031

(57) ABSTRACT

A method for assaying an analyte in a bodily fluid from a subject includes collecting a sample of the bodily fluid comprising an analyte of interest from a subject. A sample with the bodily fluid comprising the analyte of interest suitable for analysis by Matrix-Assisted Laser Desorption/Ionization Time-of-Flight Mass Spectrometry (MALDI-TOF) is then prepared. Mass spectrometry is then performed to determine mass-to-charge ratios and ion abundances of the bodily fluid or its components. The mass-to-charge ratio values and the ion abundance of each of these ratios are then analyzed using calibration standards to interpret a resulting mass spectrum and to provide quantitative information.

### CROSS REFERENCE TO RELATED APPLICATION

The present application is a non-provisional application of U.S. Provisional Patent Application No. 62/139,885, entitled “MALDI-TOF MS Method and Apparatus for Assaying an Analyte in a Bodily Fluid From a Subject” filed on Mar. 30, 2015. The entire contents of U.S. Provisional Patent Application No. 62/139,885 are herein incorporated by reference.

Recent discoveries of disease biomarkers and the establishment of mass spectrometers suitable for clinical applications have led to a recognition that automated prediction, diagnosis, and management of diseases is a realistic goal. Early diagnosis has obvious benefits in that it allows physicians to begin treatments sooner. Also, properly identifying disease and disease sub-classification allow physicians to tailor treatments to specific patients, thereby greatly improving outcomes.

Recent developments in Matrix-Assisted Laser Desorption/Ionization Time-of-Flight Mass Spectrometry (MALDI-TOF MS) provide particularly powerful tools for clinical assays of bodily fluids. These techniques provide a combination of high-sensitivity, wide-dynamic range, and high-throughput. Additionally, these techniques require transfer and analysis of only a very small volume of a sample (ca. 1 μL). These techniques are rapidly becoming practical for routine clinical testing. MALDI-TOF MS is advantageous because it provides both qualitative and quantitative information about the sample. Instruments designed for routine clinical applications are fully automated, requiring little or no operator expertise in mass spectrometry.

### BRIEF DESCRIPTION OF THE DRAWINGS

The present teaching, in accordance with preferred and exemplary embodiments, together with further advantages thereof, is more particularly described in the following detailed description, taken in conjunction with the accompanying drawings. The person skilled in the art will understand that the drawings, described below, are for illustration purposes only. The drawings are not necessarily to scale, emphasis instead generally being placed upon illustrating principles of the teaching. The drawings are not intended to limit the scope of the Applicant's teaching in any way.

FIG. 1 illustrates a block diagram of one embodiment of a MALDI-TOF Mass Spectrometer system for analysis of clinical samples.

FIG. 2 illustrates a functional block diagram of a MALDI-TOF mass spectrometer system for assaying an analyte in a bodily fluid according to the present teaching.

FIG. 3 illustrates the use of internal calibration standards for analytes, such as human hemoglobin of known mass.

FIG. 4 illustrates an expanded view of a hemoglobin spectrum that shows the singly charged α and β chains with glycation and matrix adducts.

FIG. 5 illustrates a graphical description of peak quantification using dot products.

FIG. 6A illustrates an HbA1c concentration study to evaluate an MS-based assay's ability to measure (HbA1c/(Hb+HbA1c)) over the clinically relevant range.

FIG. 6B illustrates Table 1 presenting the average (HbA1c/(Hb+HbA1c)) ratio.

FIGS. 7AA and 7AB illustrate an overlay of averaged spectra for each of seven data points in the HbA1c concentration study presented in FIG. 6A with an expansion of the HbA1c peak.

FIG. 7B illustrates a table presenting results for a 16 trial analysis of a single sample analyzed in 5× replicates.

FIG. 8 illustrates a plot of HbA1c determined by MALDI-TOF MS using calibration from FIG. 6 for sixteen clinical samples compared with HbA1c determined by the accepted LC method.

FIG. 9A summarizes the results from analysis of sixteen clinical samples with five repetitions of each on three plates for a total of fifteen determinations for each sample.

FIG. 9B illustrates the results of a plot of Hb-β glycation percent vs. HbA1c determined by the LC reference method (upper panel) and the same data corrected by a single point calibration using the value at 9% from the LC method.

### DESCRIPTION OF VARIOUS EMBODIMENTS

Reference in the specification to “one embodiment” or “an embodiment” means that a particular feature, structure, or characteristic described in connection with the embodiment is included in at least one embodiment of the teaching. The appearances of the phrase “in one embodiment” in various places in the specification are not necessarily all referring to the same embodiment.

It should be understood that the individual steps of the methods of the present teachings may be performed in any order and/or simultaneously as long as the teaching remains operable. Furthermore, it should be understood that the apparatus and methods of the present teachings can include any number or all of the described.

The methods and apparatus for MALDI-TOF mass spectrometry, according to the present teaching, provide the essential elements of a complete system for diagnostic applications in a clinical laboratory. The methods of the present teaching may employ any type of MALDI-TOF mass spectrometer, but are particularly suitable for MALDI-TOF mass spectrometers designed to provide the characteristics required for acceptance in routine clinical applications.

A MALDI-TOF mass spectrometer that provides the characteristics required for an instrument acceptable for use in the clinical environment is disclosed in co-pending application entitled “Mass Spectrometry Method and Apparatus for Clinical Diagnostic Applications,” filed on the same date as the present application. The entire content of this application is herein incorporated by reference.

A MALDI-TOF mass spectrometer apparatus for assaying an analyte in a bodily fluid from a subject that is typically located in a clinic setting that diagnoses and/or treats patients. The clinic typically has at least one clinician or other healthcare professional responsible for the diagnosis and/or treatment of a subject. The clinician specifies an assay of a bodily fluid. However, it should be understood that in some methods the clinician is the subject. There is some means for obtaining a sample suitable from the subject for the assay specified. There is also a means for transmitting the sample and information about the assay specified to the mass spectrometer system.

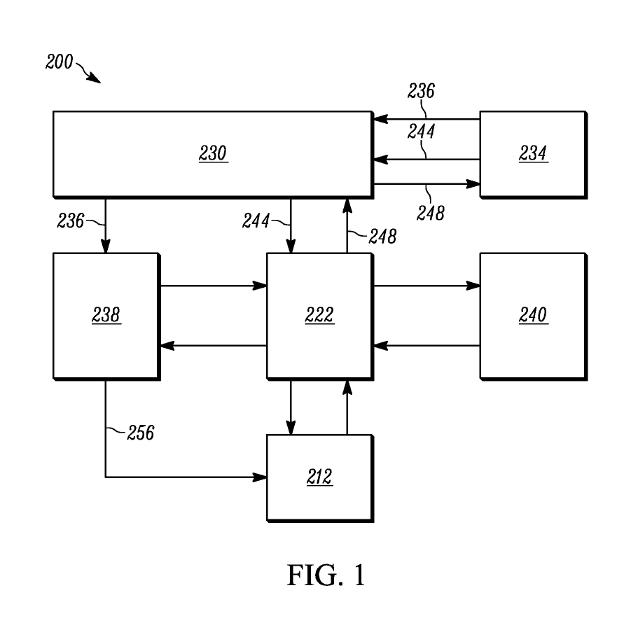

A block diagram of one embodiment of the MALDI-TOF Mass Spectrometer apparatus 200 for analysis of clinical samples is illustrated in FIG. 1. The apparatus comprises a controller 230. Unlike the known systems, this instrument does not require any direct interaction between the controller 230 and the MALDI-TOF mass spectrometer 212. Therefore, no knowledge or expertise of the mass spectrometer 212 is required. In some embodiments the controller 230 is an individual with the necessary training and expertise. In other embodiments, the controller is a computer controlled robot. The controller 230 receives sample 236 and instructions and information 244 about the sample, either in the form of text or through a barcode or similar information device, from clinical source 234 or from the subject. The controller 230 then transmits sample 236 to sample preparation system 238 and instructions and information 244 about the sample to computer 222.

Sample preparation system 238 prepares the sample 236 for analysis by MALDI according to predetermined instructions corresponding to instructions and information 244. The sample preparation system 238 may be manual or robotic. Sample plates 256 containing samples derived from sample 236 are transferred to mass spectrometer 212. In addition to carrying the samples, the sample plate 256 is labeled by a bar code that is read by the mass spectrometer 212 to correlate the sample plate with instructions and information 244. Database 240 is queried by computer 222 to determine the mass spectrometer settings that are required to execute instructions and information 244. Those settings are downloaded to the mass spectrometer 212. The resulting spectra produced by the mass spectrometer 212 are digitized by the computer 222, and are then processed and analyzed. The results are stored and interpreted by database 240. Computer 222 prepares a report on the result 248 and transmits this to controller 230 and/or clinical source 234.

An important characteristic of some mass spectrometers according to the present teaching is that the laser operates at high rates, ca. 1 kHz or higher, and the laser beam is rastered over the sample surface so that a significant fraction of the sample on the surface is ionized and the ions are efficiently detected.

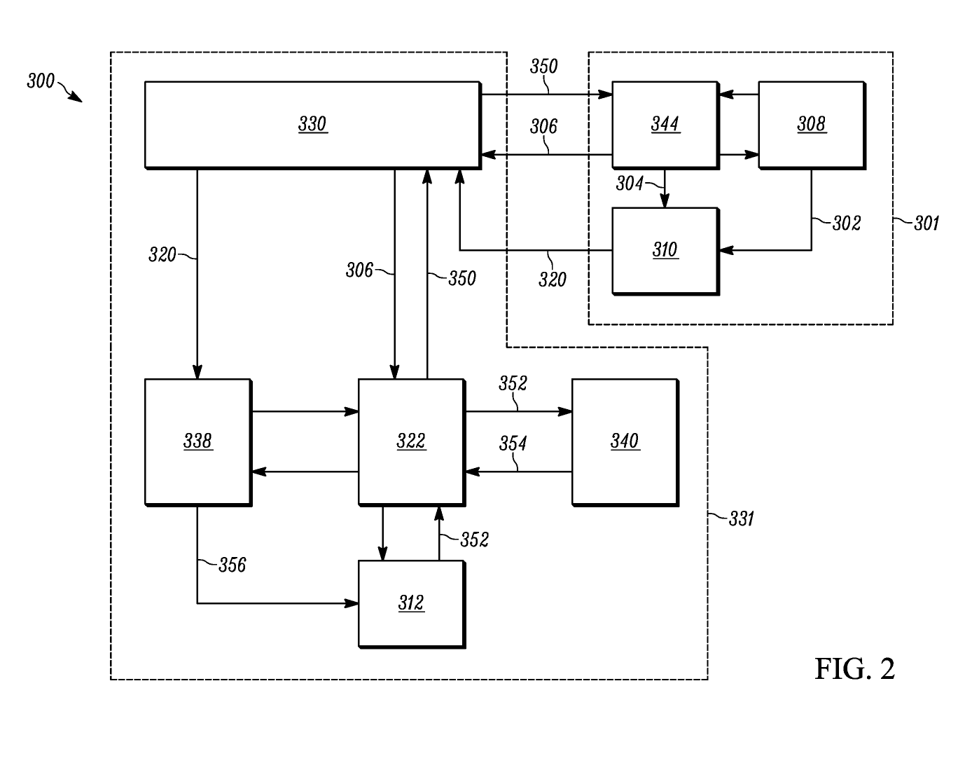

FIG. 2 illustrates a functional block diagram of a MALDI-TOF mass spectrometer system 300 for assaying an analyte in a bodily fluid according to the present teaching. A clinician 344 (or, in some cases, the subject 308 themselves) first specifies the assay order 306 of one or more analytes in bodily fluid 302 from subject 308 that is required for diagnosis or treatment of subject 308, and then orders that assay order 306 be performed. Sample collection 310 is then performed where a sample 320 of the bodily fluid 302 from the subject 308 is collected. One feature of the present teaching is that the clinic 301 comprising the subject 308, the clinician 344 and the sample collection 310 may be remotely located relative to the analytical laboratory 331 comprising the controller 330, the sample preparation 338, the computer 322, the database 340, and the mass spectrometer 312. For many applications this is most convenient and most economical.

Alternatively, the subject 308 can bypass the clinician 344, by specifying the assay order 306 themselves, collecting their own sample 320 of body fluid 302. Samples 320 and assay order 306 are transmitted from the clinic 301 (or the subject 308) to the analytical laboratory 331, and the report of the analysis 350 is returned to the clinician 344 or the subject 308. The clinic 301 and the analytical laboratory 331 may be separated by large distances in some cases and in most cases samples and results can be transmitted in less than one day within a single country.

Samples 320 are processed by the sample preparation 338 so that they are suitable for analysis by MALDI-TOF mass spectrometry and processed samples are extracted and applied to the surface of a MALDI sample plate 356. A solution containing a UV absorbing MALDI matrix is added to the sample extract on the surface of the sample plate 356. The sample plate 356 is then transferred from atmospheric pressure to the vacuum chamber of the MALDI-TOF mass spectrometer 312.

The sample extract is then ionized within the MALDI-TOF mass spectrometer 312. A time-of-flight mass spectrum 352 of the ions generated is then detected and processed using database 340. The results of the assay are then reported in the report of the analysis 350 to the clinician 344 or the subject 308. A feature of the method and apparatus of the present teaching is the ability to assay multiple components concurrently in a single sample.

MALDI-TOF mass spectrometers produce a time-of-flight (TOF) digitized spectrum of ion intensity as a function of time between ion production and detection. The time axis is converted to mass using equations known in the art that convert the spectrum into mass-to-charge ratio. Such spectra can be visualized as a vector in n-dimensional space, where n is the number of bins used to determine the digitized spectrum. A typical spectrum may consist of 50,000 or more bins.

MALDI samples distributed on a sample plate often show relatively large fluctuations in ion intensity as a function of position of the laser spot on the plate. The fluctuations depend on several factors, such as the size and distribution of matrix crystals on the plate. This effect can be minimized by taking a relatively small number of light pulses per spectrum (typically 50-100), and only saving those spectra that exceed a predetermined intensity. These saved spectra are then summed or averaged over the sample spot, and these averaged spectra are processed to produce the final spectrum for a sample spot that may represent the sum of 10,000 or more laser shots.

The methods for assaying an analyte in a bodily fluid from a subject according to the present teaching can be applied to any sample that is amenable to analysis by MALDI-TOF mass spectrometry. Steps in a method include sampling bodily fluids from subjects, processing the samples of bodily fluids collected to produce a sample extract suitable for analysis by MALDI-TOF mass spectrometry, loading the sample extract into the ion source of the MALDI-TOF mass spectrometer, ionizing the sample extract, generating a TOF mass spectrum, and analyzing and interpreting the MALDI-TOF mass spectrum generated to provide meaningful results of the assay. One feature of the methods of the present teaching is that each of the components of the method is designed to meet the requirements imposed by the nature of the bodily fluid, the analyte, and the various specifications of sensitivity, selectivity, precision and accuracy of the assay. The methods have considerable flexibility and are not “one-size-fits-all” methods. Instead, the choices made for each step of a method for a specific assay reflect the requirements.

The term “analytes,” as used in the present teaching, includes, but is not limited to, drugs, prodrugs, pharmaceutical agents, drug metabolites, endogenous metabolites, antibodies, serum proteins, cholesterol, polysaccharides, nucleic acids, biological analytes, biomarkers, genes, proteins, hormone, or any combination thereof. These analytes can be polypeptides (proteins or peptides), glycoproteins, polysaccharides, lipids, nucleic acids, small organic molecules, or a combination thereof. The predetermined components of interest characteristic of these analytes can be the intact analytes themselves, or chemically or enzymatically derived stable molecules (e.g., molecular fragments) derived from the intact molecule, such as proteolytic peptides or polysaccharides, or chemically modified forms of the original analyte (e.g., methylated, acetylated, or otherwise intentionally modified forms).

The method of the present teaching can be used to analyze any bodily fluid containing an analyte of interest. Bodily fluids include, but are not restricted to, blood and blood products (serum, plasma, platelets), ascites fluid, breast milk, cerebrospinal fluid, lymph fluid, saliva, urine, gastric and digestive fluid, tears, stool, semen (and semen-derived fluids such as aspermic semen), prostatic fluid, vaginal fluid, amniotic fluid, and interstitial fluids derived from tissue. In various methods, the bodily fluids can be drawn from a patient in a variety of ways, including lancing, needle withdrawal, or pipetting. A patient can simply provide a sample when no active mechanism is required to obtain the fluid, such as with saliva, urine, or stool.

Methods according to the present teaching are suitable for numerous routine clinical uses, including: cancer typing directly from serum, tissue extracts, and/or other bodily fluids or their extracts; tissue imaging (e.g., proteins for cancer typing or small molecules for drug disposition); biomarker identification and validation; mass spectrometric immunoassay; peptide and protein quantification, either as intact molecules or as chemically or enzymatically generated fragments (e.g., SISCAPA and other similar approaches); and clinical assays of biomarkers for diagnosis or to guide patient management.

Both diagnosis and health management are improved when more and higher accuracy personal health data are available. In some applications, a single microliter of bodily fluid will contain a sufficient quantity of analyte for many types of analysis. Other applications may require up to a milliliter of bodily fluid. Still other applications may require dilution prior to running the assay to generate optimal results. Sample dilution or extraction may help remove matrix effects and bring the target analyte concentration into the measurable range of the assay. Dilution may also provide sufficient liquid to allow multiple assays.

Methods according to the present teaching also support the identification and/or quantification of markers to help define a patient's risk of acquiring a specific disease. These methods can also be used to identify a patient's specific disease or disease subtype, to predict a patient's response to a specific therapy, to prognose (i.e., predict a patient's likely outcome independent of therapy), to assess a patient's compliance to therapy, to measure a drug or drug metabolite concentration, or to otherwise assess the clinical status of individuals with said disease. Additionally, methods according to the present teaching allow advanced workflows aimed toward discovery, validation, and routine monitoring of novel biomarkers stemming from numerous analyte-based discovery efforts currently ongoing worldwide.

More specifically, a method of the present teaching can identify and quantify analytes in serum or plasma by diluting and/or removing red blood cells and/or other interferents. When the analyte is present at low level in a sample of bodily fluid, the concentration of the target analyte(s) can be increased by conventional means to enrich the analyte. In various embodiments, drying, evaporation, centrifugation, sedimentation, precipitation, differential mobility or retention, and amplification are used. A particularly powerful method of enrichment employs an appropriate antibody to capture the analyte of interest.

For example, current diagnosis and monitoring of diabetes mellitus relies on measurements of the amount of glucose attached to the N-terminus of the beta-subunit of hemoglobin (HbA1c), which is typically measured without using mass spectrometry. Development and validation of an assay for hemoglobin (HbA1c) according to the present teaching illustrates the steps involved in producing a clinically valid assay employing MALDI mass spectrometry. The first step is to select a clinically relevant analyte. This may be one that is already widely measured, such as HbA1c, or one that has been demonstrated to be potentially important, but where no clinically accepted analyte is currently available. The goal in the former case is an assay that is better, faster, and less expensive than those currently in use.

The next step is to develop and validate the processes for acquiring the sample of bodily fluid, processing the fluid to produce an extract suitable for MALDI-TOF analysis, and depositing the extract with MALDI matrix on the MALDI sample plate. The final step is to establish the procedures for analysis of the sample by MALDI-TOF and reporting the results. This involves a choice of parameters, such as laser intensity, mass range, laser pulse repetition rate, and a method for scanning the laser over the sample on the MALDI plate. The time-of-flight spectra are recorded and analyzed to produce the final result which is needed for interpretation and/or reporting the result of the assay. When development and validation are completed for a particular assay, this information is then stored in the database. Specification of an assay included in the database automatically sets the conditions for sample processing and mass spectrometric analysis that are required for that assay.

Referring back to FIG. 2, in one assay according to the present teaching, the analytes are hemoglobin and predetermined hemoglobin-derived components in bodily fluid 302 that is a single droplet of whole blood. In these methods, the predetermined sub-components of interest are the alpha and beta chains of hemoglobin, together with glycated modifications of these same chains. This is where a glucose molecule is clinically fixed (covalently bound) to the hemoglobin chain.

For example, the bodily fluid 302 that can be a single droplet of whole blood may be withdrawn from the subject 308 by a finger stick using a lancet. Alternatively, a syringe, needle, or other means is used to withdraw the blood directly from the subject 308. The bodily fluid 302 can also be a larger volume of blood or any volume of other bodily fluid. The nominal volume of blood in a single droplet of whole blood may be as little as 1 microliter. Unlike prior art analytical techniques, the actual volume is not critical to the results. The droplet is then diluted by a factor of about 2,000 in sterile deionized water, and then ca. 1 microliter of the diluted blood sample is spotted onto the MALDI sample plate 332 along with a UV absorbing MALDI matrix comprising ca. 1 microliter of sinapinic acid matrix solution. It is then allowed to dry. Thus, less than 1 nanoliter of blood is actually required for the analysis with this technique. However, one skilled in the art will appreciate that it is difficult to obtain such small samples without introducing contamination from extraneous sources.

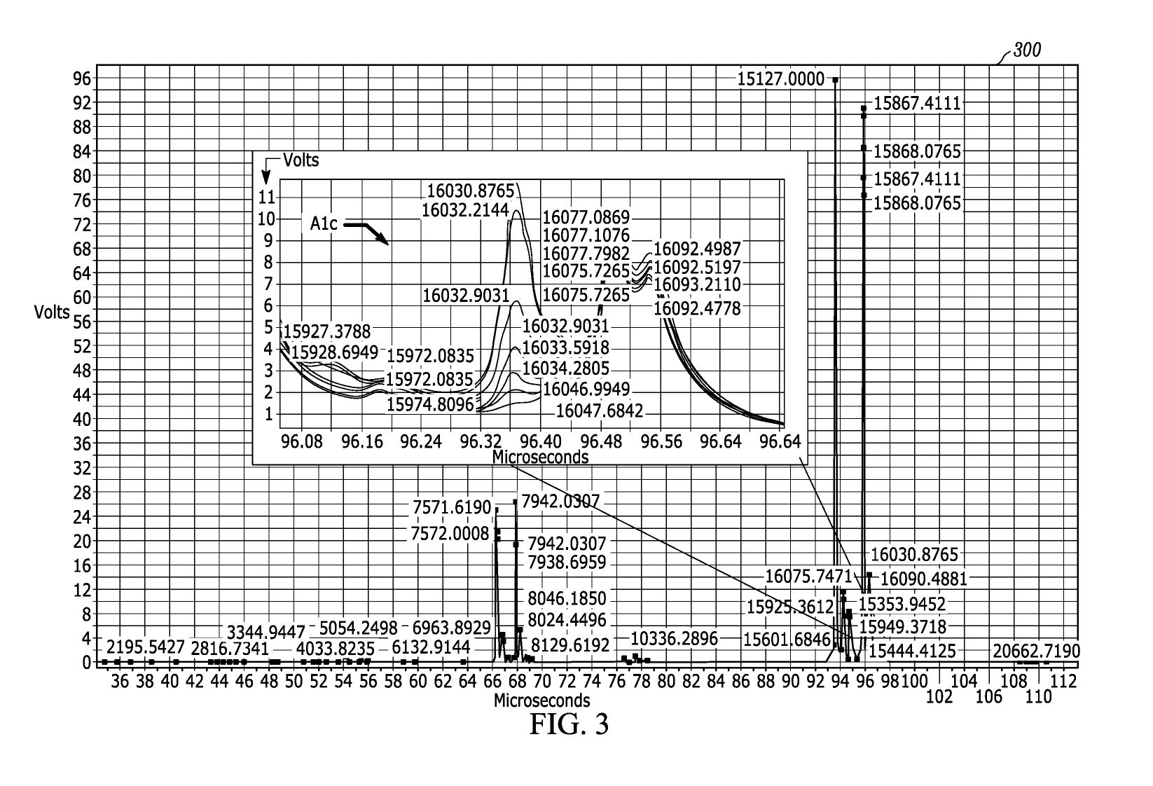

FIG. 3 illustrates the use of internal calibration standards for analytes, such as human hemoglobin of known mass. After baseline correction and four point internal calibration on the main peaks of singly and doubly charged hemoglobin, the raw intensities are redistributed into a binned spectrum where the mass bin difference is the mass of beta hemoglobin's main peak divided by 10,000 (about 1.586 amu). Both the main peak for hemoglobin beta at m/z 15,868 and the glycosylated hemoglobin peak (adduct peak) at m/z 16,030 (162 amu higher than the main peak) are mapped to a Gaussian peak centered on the main peak, and on the known position of the adduct peak, regardless of whether the adduct peak is well resolved or easily detectable using most peak detection algorithms. Thus, the process of measuring the intensity of the adduct peak is completely separate from measuring the mass of the peak.

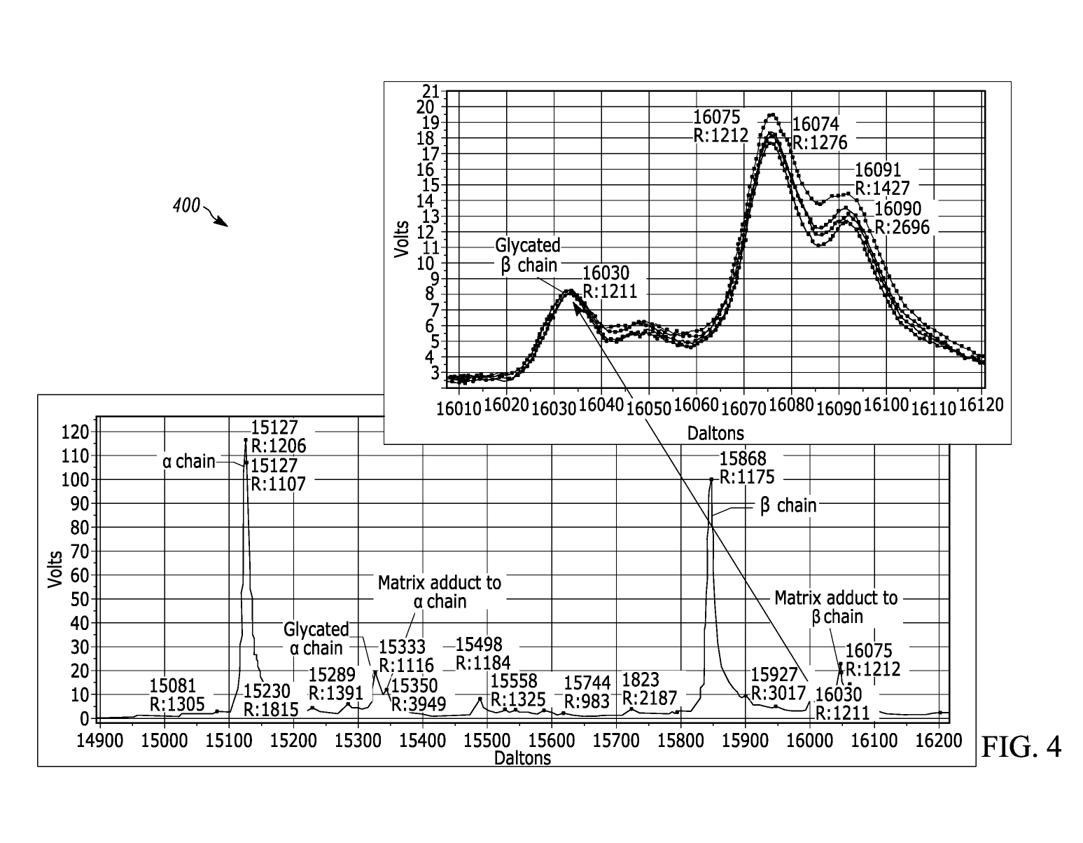

FIG. 4 illustrates an expanded view of a hemoglobin spectrum that shows the singly charged α and β chains with glycation and matrix adducts. These molecules are detected and their relative amounts are quantified in the mass spectrum illustrated in FIG. 4 at nominal masses 15,127, 15,289, 15,868, and 16,030 Da for singly charged ions, and at 7,565, 7,646, 7,935.5, and 8,016.5 Da for doubly charged ions.

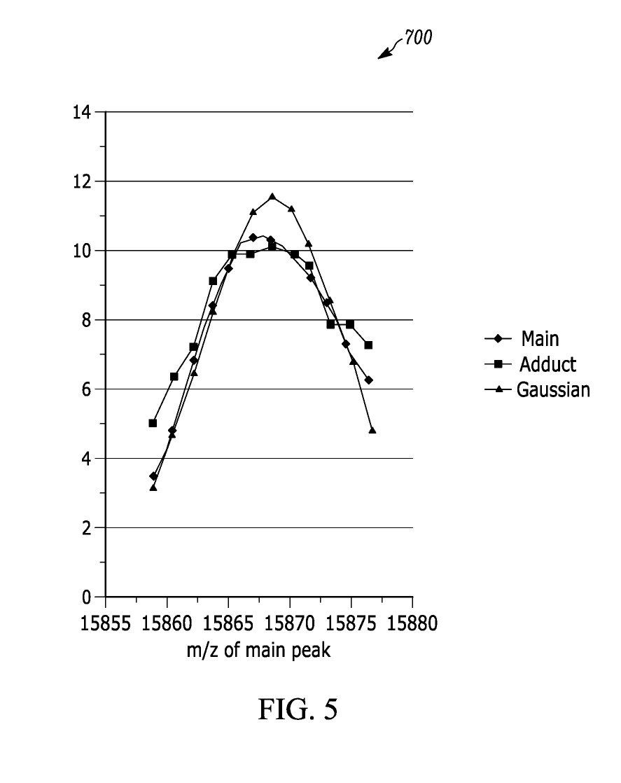

FIG. 5 illustrates a graphical depiction of peak quantification 700 using dot products. Peak quantification is achieved by calculating the dot product of each peak to the Gaussian. The intensity scale of the three curves shown in FIG. 5 has been normalized. The dot product is calculated from 12 different bins for each. Experiments indicate that doubling the number of bins or reducing the number of bins to eight has little impact on the results. The desired intensity ratio is simply the ratio of the intensity of dot products prior to normalization. The same 12 bins are used for all of the samples in the dataset, including standards for which the percent of glycated hemoglobin has been measured by independent means.

Similar calculations can be performed on the hemoglobin alpha chain, and doubly and triply charged forms of both hemoglobin alpha and beta. The same process can be used to measure percent glycation of any peak in the spectrum, so long as the main peak has a known mass. This approach is not limited to human subjects, but also can be used for quantification of glycated hemoglobin from animal species where hemoglobin masses can be calculated from protein sequences. It can even be used for blood samples with unknown hemoglobin masses. In the case of an undefined hemoglobin variant or poorly studied animal species, the calculation can still be performed based on the measured mass of the main peak, using external standards if necessary.

The mass spectrometer response can be calibrated by generating a standard curve. Lyophilized hemoglobin was weighed and diluted to create a range of protein concentrations; triplicate absorbance measurements at each concentration were averaged and used to construct an absorbance based calibration curve. Hb and HbA1c separated from a BioRad HbA1c calibration standard were collected and reanalyzed by absorbance against our calibration curve for protein concentration determination. Isolated Hb and HbA1c were then remixed in various defined proportions to mimic and span clinically relevant HbA1c blood levels (0-20%). Constructed standards were then analyzed by MALDI MS to create an MS calibration curve.

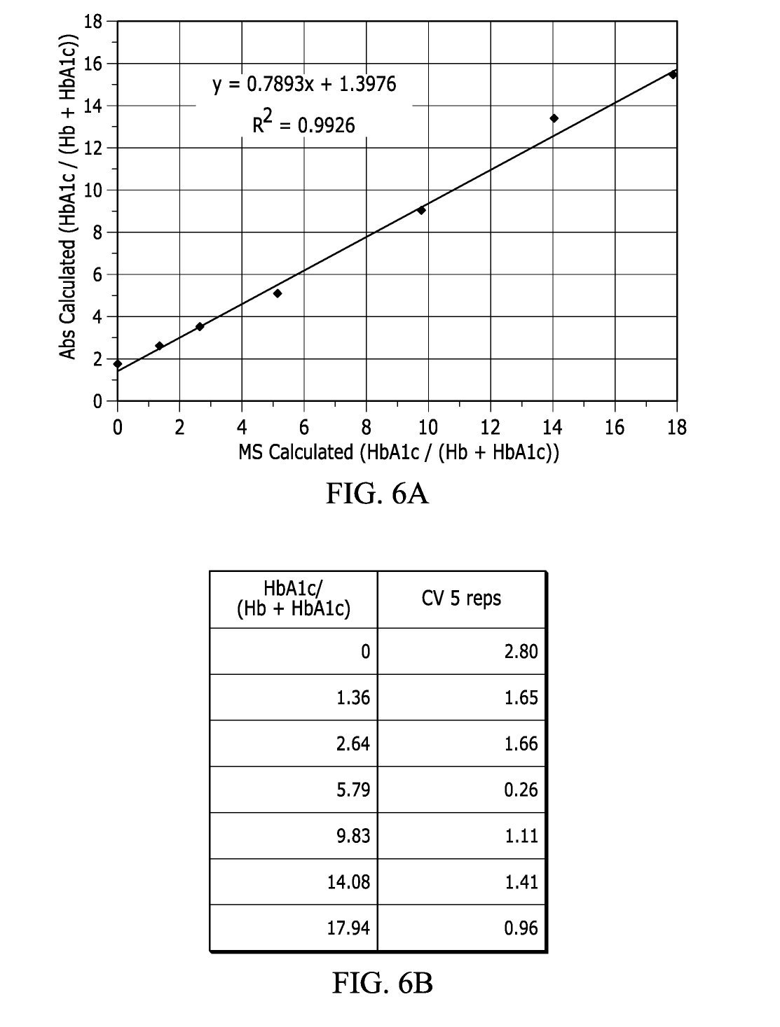

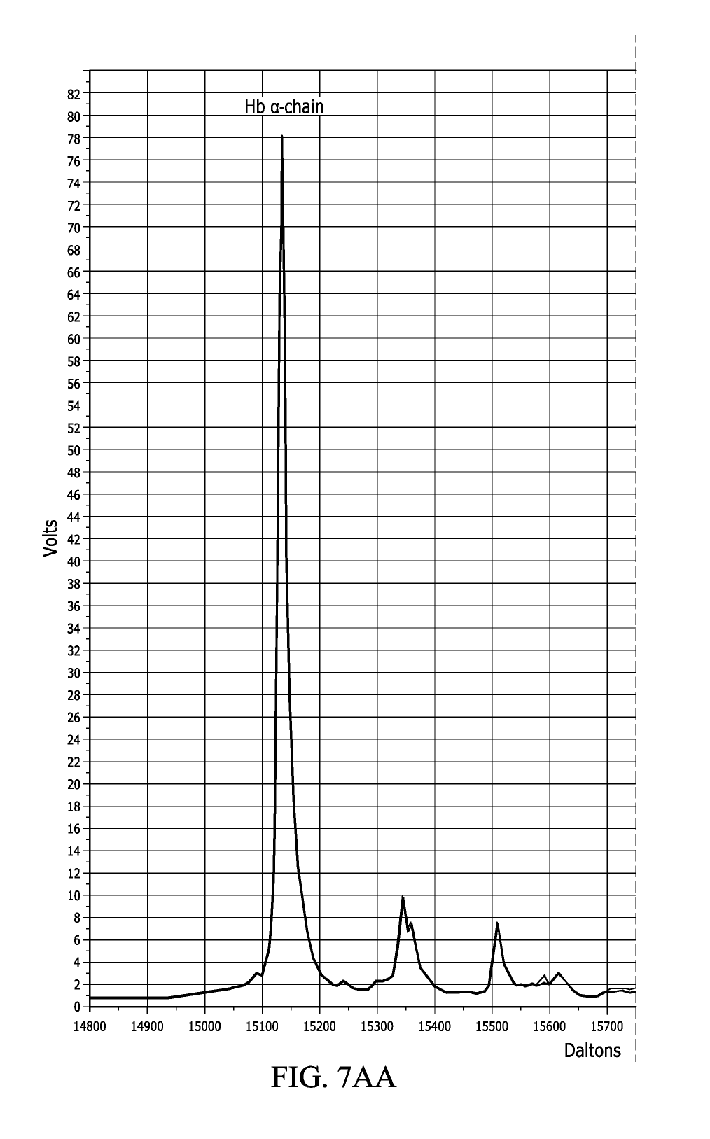

FIG. 6A illustrates an HbA1c concentration study to evaluate an MS-based assay's ability to measure (HbA1c/(Hb+HbA1c)) over the clinically relevant range. In particular, FIG. 6A shows the results obtained by MS plotted against those obtained by absorbance with the seven data points used in curve construction. Inversion of the results shown in FIG. 6A yields a calibration curve for calculating the absolute concentration of HbA1c from MALDI-TOF MS measurement of the glycated β chain relative to the unglycated β chain. The result is: [HbA1c/(Hb+HbA1c)]=1.267[I_{HG}/(I_{H}+I_{HG)})]−1.77, where I_{HG} and I_{H} are the intensities of the glycated and unglycated peaks, respectively.

FIG. 6B presents a table of the average (HbA1c/(Hb+HbA1c)) ratio calculated at each calibration point and the coefficient of variance calculated from amongst the five replicates at each concentration.

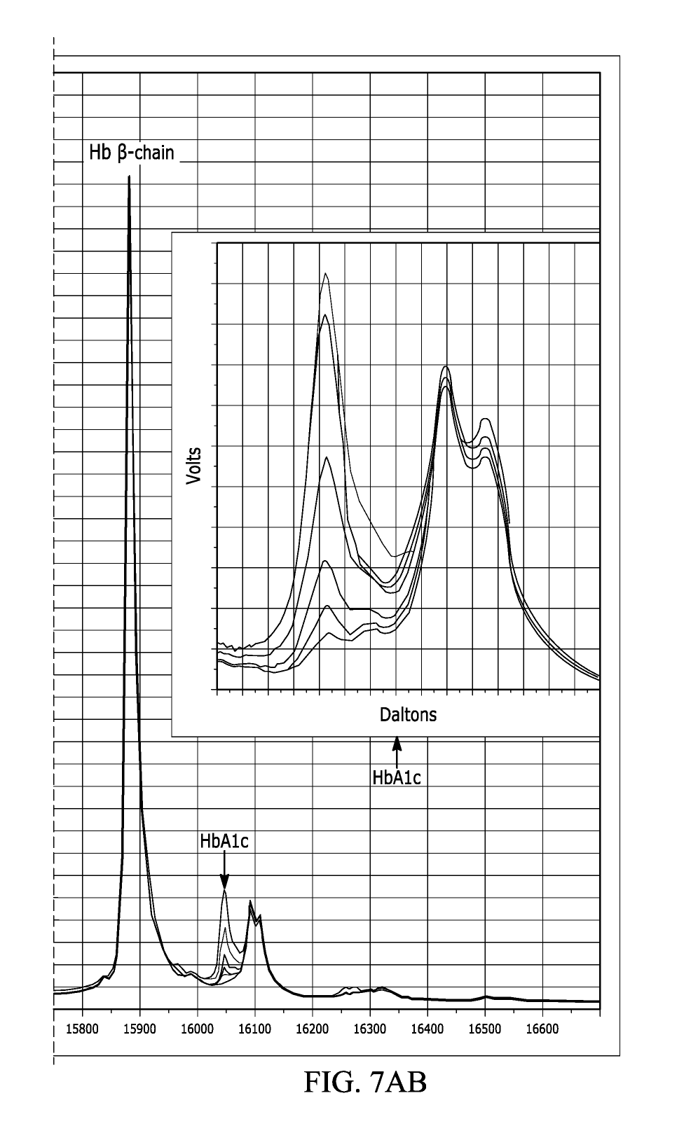

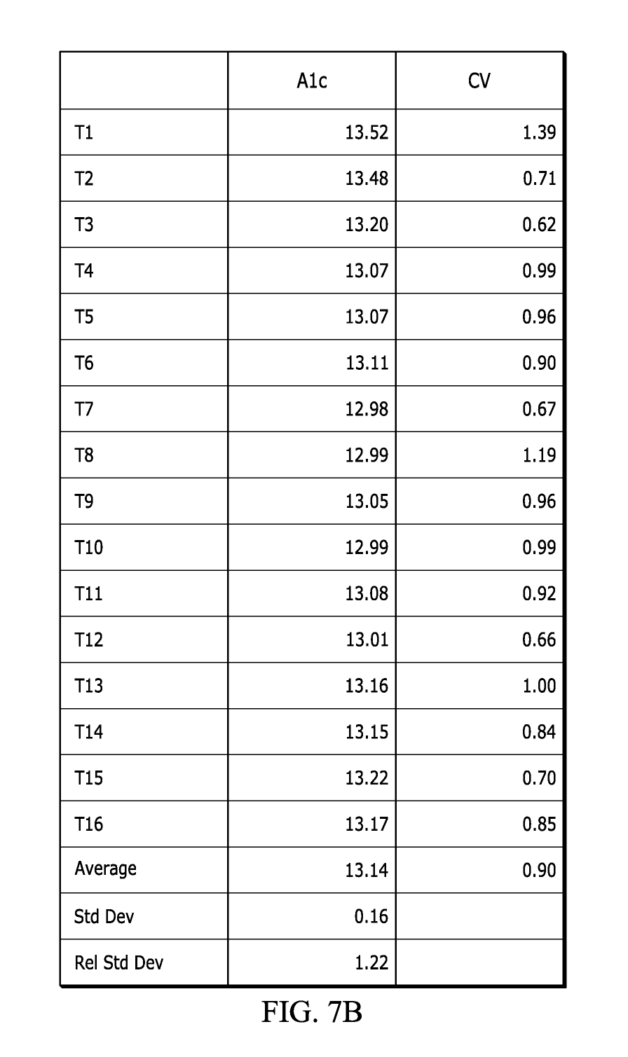

FIGS. 7AA and 7AB illustrate an overlay of averaged spectra for each of seven data points in the HbA1c concentration study presented in FIG. 6A with an expansion of the HbA1c peak. FIG. 7B illustrates a table presenting results for a sixteen trial analysis of a single sample analyzed in 5× replicates. Data in the table of FIG. 7B demonstrate the reproducibility of the MS assay by comparing results for sixteen separate analyses of a single sample analyzed in 5× replicates.

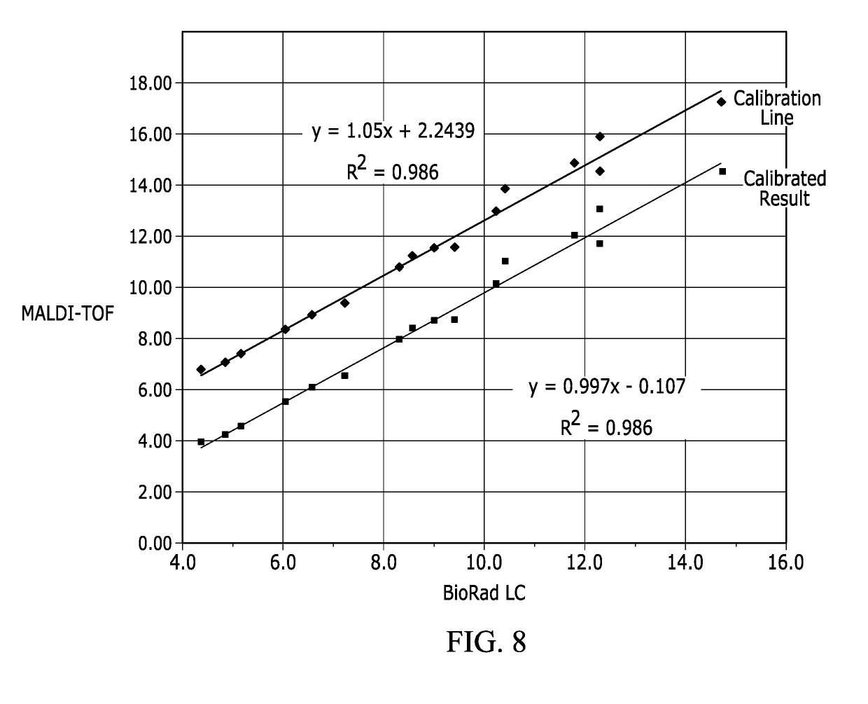

FIG. 8 illustrates a plot of the glycated fractions for a and chain measured by MALDI-TOF MS for sixteen clinical samples versus HbA1c determined by a validated LC method. These plots can be inverted to provide calibration equations linking the measured glycated fractions to HbA1c, as determined by the validated LC method. The calibration equations are: HbA1c=0.95y_{β}−2.137, where y_{β} is the ratio (percent) of the glycated β relative to the sum of glycated and unglycated β, and also: HbA1c=1.496y_{α}−2.137, where y_{α} is the ratio (percent) of the glycated α relative to the sum of glycated and unglycated α.

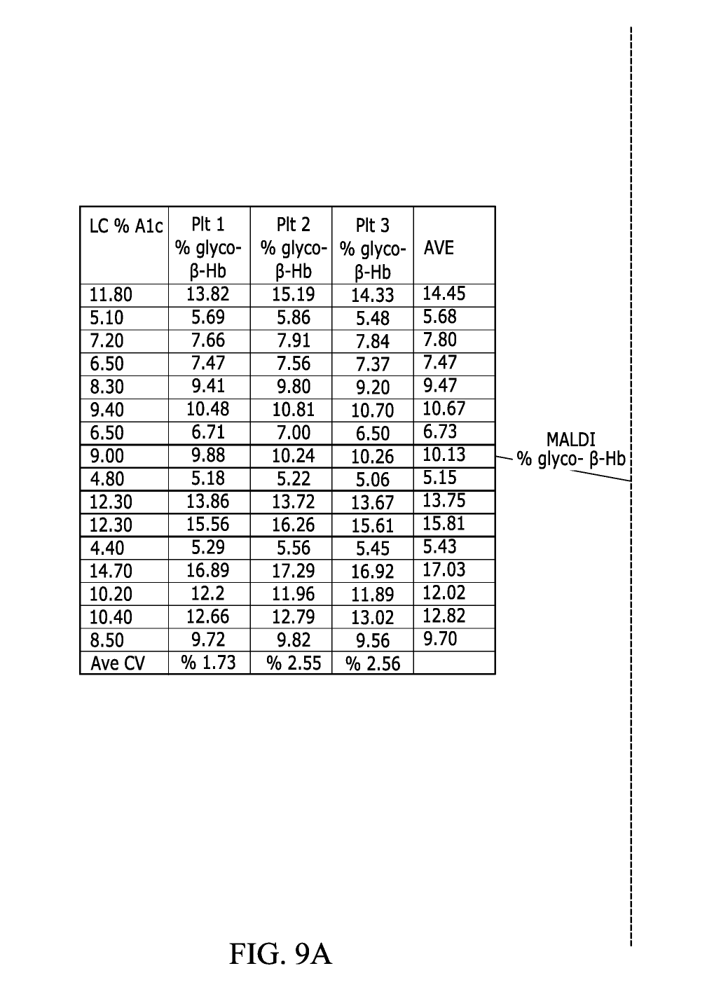

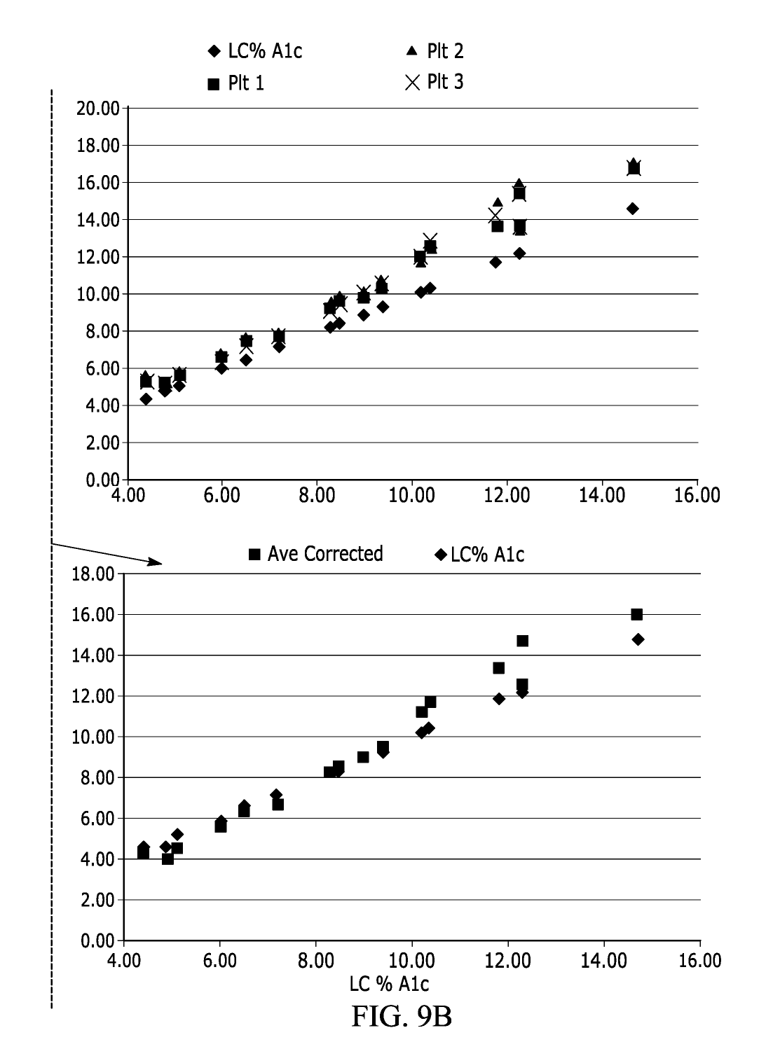

It is known that measurement of total glycation of hemoglobin b chain includes glycation of the lysine residues in addition to the n-terminal glycation that is defined as HbA1c. Thus, the measurements by MALDI-TOF are expected to be systematically higher due to this effect. A single point calibration using a standard allows an accurate correction for this effect. Results from a total of fifteen measurements on sixteen clinical samples are summarized in FIGS. 9A and 9B.

FIG. 9A summarizes the results from analysis of sixteen clinical samples with five repetitions of each on three plates for a total of fifteen determinations for each sample. FIG. 9B illustrates the results of a plot of Hb-β glycation percent Vs. HbA1c determined by the LC reference method (upper panel) and the same data corrected by a single point calibration using the value at 9% from the LC method. As illustrated in FIG. 9, calibration at a nominal level of 9% brings the MALDI-TOF results in excellent agreement with the LC method throughout the clinically relevant range.

In one embodiment of the method of the present teaching, the target analyte is C-reactive protein (CRP), a protein made by the liver and released into the bloodstream within a few hours after tissue injury, the start of an infection, or as a consequence of other causes of inflammation. CRP is frequently measured in plasma by clinicians to check for inflammation in the body. For example, increased CRP can be used to indicate a flare-up of inflammatory diseases such as rheumatoid arthritis, lupus, or vasculitis, or to determine if an anti-inflammatory medication is working to treat a disease or condition. A variant of this test, called a high-sensitivity C-reactive protein (hs-CRP) assay, is commonly used to determine a person's risk for heart disease. CRP can be quantified by the approach describe herein.

Another embodiment of the method of the present teaching involves the measurement of serum amyloid A (SAA) and its variants in blood, plasma, or serum. SAA and its variants (isoforms) are acute phase markers that respond rapidly to many stimuli. The magnitude of the increase may be greater than that observed for CRP, but SAA is not widely adopted as a marker because multiple closely related forms are released. It is difficult to accurately quantify any single form without interference from the other forms. However, because of the selectively of MALDI mass spectrometry, the methods of the present teaching allows the precise determination of any or all of SAA's variants.

In yet another embodiment of the method of the present teaching, an abundant blood protein is quantified in blood, serum, or plasma by measuring stable fragments of the protein that are formed chemically or enzymatically, either in-vivo or by steps performed after the sample is collected. Albumin, for example, is a protein made by the liver. Determining the concentration of albumin can aid the physician in determining whether a patient has liver disease or kidney disease, or if the body is not absorbing enough protein. For this method, a drop of whole blood is collected from the subject by a finger stick using a lancet, or is obtained from a larger volume of blood drawn by using a syringe and needle. Peptide fragments of albumin, either formed in-vivo or intentionally generated by enzymes (e.g., trypsin) or chemicals (e.g., cyanogen bromide), are then quantified as surrogates of albumin. Amounts of these fragments are then used to estimate the amount of total albumin, or endogenous albumin fragments, in the original blood sample.

One feature of the method of the present teaching is that a concentration step can be used in some embodiments. When there is insufficient analyte in a single droplet of blood to allow quantification, a concentration step may be necessary. For these applications, a larger volume of blood is collected and the target analyte is extracted and concentrated from that larger volume. Various methods can accomplish extraction, such as, centrifugation, sedimentation, precipitation, solvent extraction, solid phase extraction, or immuno-based approaches based on antibodies.

The concentration step is followed by a quantification step that provides precise quantification of multiple analytes of clinical relevance. Of particular interest are the detection and/or quantification of molecules that characterize a particular disease or specific disease stage. These molecules are commonly referred to as biomarkers. Such biomarkers or other analytes include, but are not limited to, those associated with autoimmune diseases, cancer, obesity, hypertension, diabetes, neuronal and/or muscular degenerative diseases, cardiac diseases, endocrine disorders, and any combinations thereof. For example, the following typically low abundance proteins can be used as biomarkers: (1) levels of growth hormone (hGH) and other pituitary hormones, which are used to diagnose endocrine disorders, such as acromegaly; proteins including CA-12; (2) prostate specific antigen (PSA), and S100, which are used to detect and monitor specific forms of cancer; (3) cardiac troponin, creatinine kinase (CK), CK-MB, and myoglobin, which are protein markers used to diagnose a heart attack; and (4) insulin and C-peptide that are used in the diagnosis and treatment of diabetes. Precise measurement of these proteins and many other biochemical markers will require larger blood volumes, as well as the incorporation of a concentration step.

In some methods according to the present teaching, when the predetermined components are present at a low level in a sample of blood or other bodily fluid, a larger volume of sample (i.e. bodily fluid) may be required to obtain a sufficient amount of biomarkers. The concentration of the target biomarker(s) can be increased by conventional means. Methods include drying, evaporation, centrifugation, sedimentation, precipitation, differential mobility, solubility or retention, and amplification. One particularly powerful method of enrichment uses an appropriate antibody to capture a specific component of interest.

Other applications of the methods and apparatus of the present teaching are biomarkers that are present in varying abundance in one or more of the body tissues, including heart, liver, prostate, lung, kidney, bone marrow, skin, bladder, brain, muscles, nerves, and selected tissues that are affected by various disease, such as different types of cancer (malignant or non-metastatic), autoimmune diseases, inflammatory, or degenerative diseases.

Referring back to FIG. 2, in one embodiment of the method of the present teaching for disease detection, the analyte is contained in bodily fluid 302. A single droplet of whole blood, and either the analyte itself, or predetermined components of interest characteristic of the analyte, are proteins or other molecular species in the blood plasma or serum that are biomarkers for specific disease states. In this embodiment, the sample preparation 338 may comprise removal of red blood cells and dilution of the plasma to reduce the concentration of other interferents, wherein the sample of bodily fluid is prepared to provide a processed sample or extract suitable for analysis by MALDI-TOF mass spectrometry 312. For many of these applications, the blood can be collected onto an adsorbant surface (e.g., cellulose) and the blood volume is calculated by any of several established methods (e.g., increase in weight, surface area). The blood volume is required so that the amount of the specific analyte measured can be expressed in terms of per unit volume of blood. Alternatively, the amount of the target analyte can be expressed as a ratio with respect to some other component of blood.

The presence of immunoglobulin light chain can be assessed in serum, urine, or other biofluids directly or following affinity purification using Protein A, Protein G, or Protein L. Determination of the clonality of the light chain molecules can be determined by measuring the resolution of the light chain peak, comparison to normal serum standards, and comparison to monoclonal antibody standards. Unusual sharpness of the peak representing the light chain is indicative of diseases such as myeloma, multiple sclerosis, or monoclonal gammopathy of unknown significance (MGUS).

Another application of the methods and apparatus of the present teaching is to measure the level of beta-2 microglobulin (B2m) following immuno-affinity chromatography, present in serum, urine, or other biofluids. Increased levels of B2m have been observed in cases of kidney disease, following certain infections, and with certain tumors.

Another application of the methods and apparatus of the present teaching is to measure the level of S-100 proteins. S-100 proteins are small (34 to 147 amino acid long) calcium binding proteins whose concentration has been shown to change in various bodily fluids, including blood and saliva and in the context of a wide number of diseases such as inflammatory diseases (e.g., psoriasis). S-100 proteins can also serve as tumor markers or markers of epithelial cell differentiation. They are well-suited for MALDI-based analysis because of their low molecular weight and their relative abundance. In addition, they can be separated from large quantities of other proteins by virtue of their high solubility in high concentrations of ammonium sulfate.

Saliva and urine samples can also be analyzed with the methods of the present teaching. For example, saliva can be assayed with minimal purification for the presence of certain S-100 proteins. First, the saliva sample is spun for one minute at 12,000 rpm. The pellet is resuspended in 0.1% TFA, and spun a second time for five minutes. The supernatant is then spotted onto a MALDI plate together with matrix (e.g. α-cyano-4-hydroxycinnamic acid (HCCA) or sinapinic acid), and linear MALDI mass spectra are acquired. Masses can be correlated with proteins detected by peptide mass fingerprinting, starting from tryptic digests of the same sample. The molecular weights of the various S-100 proteins are generally in the range 3-16 kDa. Most of the S-100 proteins can be readily distinguished by linear MALDI. It is likely that each protein can be modified by truncation, disulfide bond formation, and chemical modification. These modifications can be detected and quantified by MALDI-TOF. Less abundant S-100 proteins may require immunoaffinity purification.

When the predetermined components are present at a low level in a sample of blood or other bodily fluid, a larger volume of analyte may be required to obtain a sufficient number of biomarker molecules for detection and precise quantification. The concentration of the target marker(s) can be increased by conventional means. Methods include drying, evaporation, centrifugation, sedimentation, precipitation, differential mobility or retention, ion exchange and amplification. A particularly powerful method of enrichment employs an appropriate antibody to capture a specific component of interest. An example of a targeted analyte that requires concentration is the biomarker and diagnostic substance known as troponin, which is commonly used for the diagnosis of various heart disorders. Functional or healthy troponin occurs as a complex of three subunits that are distinguished by name as troponin C, troponin I, and troponin T. Physiologically, the troponin complex is involved in the contraction of cardiac and skeletal muscle diseases. More specifically, measurement and quantification of troponin subtypes T and I in blood are used as indicators of damage to heart muscle. These measurements are diagnostic, and are used to differentiate between unstable angina and myocardial infarction (heart attack) in people with chest pain or acute coronary syndrome. In addition, non-thrombotic cardiac conditions (myocardial contusion, infiltrative myocardial diseases) and non-thrombotic diagnoses (sepsis, pulmonary embolism, stroke, renal failure) are also associated with elevated levels of troponin.

The current prognostic threshold for troponin T in blood is 0.01 ug/L or ˜1 pmol/L (1×10⁻¹² M). This concentration is below the current detection threshold of many state-of-the-art MALDI instruments, particularly if the molecule remains as a minor constituent in blood. However, affinity capture chemistry employing target bound antibodies for the specific extraction and concentration of troponin can enable detection and quantification. Inclusion of a synthetic troponin analogue, or a labeled form of troponin with heavy isotopes, can be used to make quantitative measurements. One skilled in the art can estimate relative protein concentrations using protein affinity purification with antibodies, the employment of synthetic isotopically labeled controls, and the incorporation of a calibration curve.

Alternatively, these technologies may require integration onto novel substrates specifically designed to operate as one of the electrodes in the applied accelerating field of the MALDI mass spectrometer of the present teaching. For this purpose, these materials must be sufficiently conductive to allow the entire substrate surface to be maintained at a potential set and controlled by the mass spectrometer. Thus, another feature of the present teaching is that in some embodiments, materials that are either designed with innate qualities of electrical conductivity, or that can be rendered electrically conductive by the application or inclusion of an electrically conductive material into their construction, are used directly as attachment substrates for antibodies. See, for example, U.S. Patent Application Ser. No. 62/127,250, entitled “Electrically Conductive and Filtrating Substrates for Mass Spectrometry,” which is assigned to the present assignee. The entire contents of U.S. Patent Application Ser. No. 62/127,250 are incorporated herein by reference.

Also, in some embodiments, materials can be chemically modified to serve as capture substrates for the target analytes that have been captured and purposefully released from antibodies to enable detection and/or quantification by MALDI mass spectrometry. These materials are sufficiently conductive to allow the entire substrate surface to be maintained at a potential set and controlled by the mass spectrometer, despite the fact that ions of a particular polarity (either positive or negative) will be desorbed from the surface. These materials may have any chemical composition, such as cellulose, plastic, metal, polymeric, glass, or any combination thereof. These materials may be composed of a single continuous substrate or may be in the form of a woven or matted material composed of numerous individual pieces that have been chemically or mechanically joined together to form a continuous structure. Additionally, these materials may be solid and porous (specifically designed to contain through-pores or voids) to allow the passage of ambient or carrier solution.

Referring back again to the MALDI-TOF MS method 300 shown in FIG. 2, the collected sample 320 of the bodily fluid 302 from subject 308 is deposited in a sample collection container during a sample collection process 310. Sample collection is optimized for the detection and/or quantification of a specific target in low concentration. In some embodiments, the sample collection 310 uses a simple containment vessel housing an affinity capture substrate. Once the sample is deposited, it undergoes sample preparation 338. The initial processing step may include mere incubation or mixing to enable antibody/antigen reaction. Post incubation, the affinity capture substrate is removed from the bulk sample where it may undergo the steps of rinsing and drying. At this stage, the sample is ready for MALDI matrix coating and direct analysis in the mass spectrometer 312. Alternatively, the analyte may be eluted off the affinity capture substrate prior to matrix addition and MALDI analysis.

The specific steps of the method of the current teaching depend on the characteristics of the analyte in question. Using troponin as an example, the intact molecular weight of the molecule is approximately 17,000 Da. This mass is within the mass range (1,000-40,000) that is well suited for direct analysis by MALDI MS. There are features other than mass, such as the attachment of carbohydrate or possession of an innate, unusual amount of molecular charge, that influence the efficiency of the MALDI ionization process. However, these cases are the exception rather than the norm. Generally, if sufficient analyte can be extracted from the parent sample, sample preparation can be optimized to induce ionization and subsequent detection and quantification.

Another feature of the MALDI method of the current teaching is the inclusion or addition of an internal standard for quantification: e.g., an isotopically labeled or chemically modified analogue, or a structural analogue (or variant) of the target analyte. This step may be done at the point of mass spectrometer analysis. This internal standard will possess a resolvable mass difference from the target analyte, and should not inhibit MALDI ionization. Added in known quantity, the signal generated by the analogue of the analyte can be compared to that of the analyte isolated from the sample by way of a calibration curve, and in this way both accurate and precise quantification is possible. Performance of comparative quantitation by such a method has well-established precedence in analytical and bio-analytical chemistry.

One skilled in the art will appreciate that troponin is only one of numerous diagnostic biomarkers that can be analyzed by the above methodology. Even with respect to myocardial infarction alone, other protein markers, such as creatine kinase and myosin light-chain, may also be targeted for analysis in a multiplexed assay.

### EQUIVALENTS

While the Applicant's teaching is described in conjunction with various embodiments, it is not intended that the Applicant's teaching be limited to such embodiments. On the contrary, the Applicant's teaching encompasses various alternatives, modifications, and equivalents, as will be appreciated by those of skill in the art, which may be made therein without departing from the spirit and scope of the teaching.

We claim:

1. A method for assaying an analyte of interest in a bodily fluid from a subject, the method comprising:
a) collecting a sample of the bodily fluid comprising the analyte of interest from the subject;
b) preparing the sample of the bodily fluid comprising the analyte of interest suitable for analysis by Matrix-Assisted Laser Desorption/Ionization Time-of-Flight (MALDI-TOF) mass spectrometry;
c) performing MALDI-TOF mass spectrometry saving only spectra that exceed a predetermined intensity level;
d) determining mass-to-charge ratios of the bodily fluid comprising the analyte of interest from the saved spectra; and
e) analyzing the mass-to-charge ratios to interpret a resulting mass spectrum.

2. The method of claim 1 wherein the determining the mass-to-charge ratios of the bodily fluid comprising the analyte of interest from the saved spectra comprises averaging the saved spectra over a sample spot.

3. The method of claim 1 wherein the performing MALDI-TOF mass spectrometry comprises scanning ionizing light pulses across a predetermined area of the sample of the bodily fluid comprising the analyte of interest.

4. The method of claim 1 wherein the performing MALDI-TOF mass spectrometry comprises ionizing the sample of the bodily fluid comprising the analyte of interest with a laser and irradiating a spot on the sample with a plurality of light pulses.

5. The method of claim 4 wherein a number of the plurality of light pulses is chosen to result in a reproducible resulting mass spectrum.

6. The method of claim 4 wherein a number of the plurality of light pulses is chosen to reduce noise in the resulting mass spectrum.

7. The method of claim 4 wherein the performing MALDI-TOF mass spectrometry comprises using less than one-hundred light pulses.

8. The method of claim 1 wherein the preparing the sample with the bodily fluid comprising the analyte of interest comprises embedding the sample in matrix crystals deposited on a surface of a sample plate that comprises one electrode of an ion accelerator in a mass spectrometer used to perform the MALDI-TOF mass spectrometry.

9. The method of claim 1 wherein the analyte of interest comprises a biomarker.

10. The method of claim 1 wherein the bodily fluid comprising the analyte of interest comprises at least one of blood, blood serum, blood plasma, blood platelets, ascites fluid, breast milk, cerebrospinal fluid, lymph fluid, saliva, urine, gastric and digestive fluid, tears, stool, semen, semen-derived fluids, such as aspermic semen, prostatic fluid, vaginal fluid, amniotic fluid, and, interstitial fluids derived from tissue or tissue biopsies.

11. The method of claim 1 wherein the collecting the sample of the bodily fluid comprises at least one of lancing, needle withdrawal, and pipetting.

12. The method of claim 1 wherein the preparing the sample of the bodily fluid suitable for analysis by MALDI-TOF mass spectrometry comprises performing at least one of dilution, separation, concentration by drying, evaporation, centrifugation, sedimentation, precipitation, differential mobility or retention, ion exchange, amplification, and antibody capture.

13. The method of claim 1 wherein the analyzing the mass-to-charge ratios to interpret the resulting mass spectrum comprises using calibration standards so that the determining the mass-to-charge ratios of the bodily fluid from the saved spectra is separate from the performing MALDI-TOF mass spectrometry.

14. A method of Matrix-Assisted Laser Desorption/Ionization Time-of-Flight (MALDI-TOF) mass spectrometry for assaying one or more analytes, the method comprising:
a) specifying an assay of the one or more analytes of interest in a bodily fluid from a subject for diagnosis;
b) collecting a sample of the bodily fluid comprising the one or more analytes of interest from the subject;
c) preparing the sample of the bodily fluid comprising the one or more analytes of interest suitable for analysis by MALDI-TOF mass spectrometry;
d) transferring the sample of the bodily fluid comprising the one or more analytes of interest to a sample plate wherein a solution containing a UV absorbing MALDI matrix is added to the sample;
e) transferring the sample plate to a vacuum chamber for MALDI TOF mass spectrometry;
f) ionizing the sample of the bodily fluid comprising the one or more analytes of interest and the UV absorbing MALDI matrix on the sample plate with a laser generating a plurality of light pulses;
g) generating a mass spectrum from the ionized sample with the bodily fluid comprising the one or more analytes of interest and the UV absorbing MALDI matrix; and
h) quantitatively determining an amount of the one or more analytes of interest from a one or more ion intensities in the mass spectrum.

15. The method of claim 14 further comprising scanning the plurality of light pulses across a predetermined area of the sample of the bodily fluid comprising the one or more analytes of interest and the UV absorbing MALDI matrix.

16. The method of claim 14 wherein the ionizing the sample of the bodily fluid comprising the one or more analytes of interest and the UV absorbing MALDI matrix on the sample plate with the laser comprises irradiating a spot on the sample with the plurality of light pulses.

17. The method of claim 16 wherein a number of the plurality of light pulses is greater than 10,000.

18. The method of claim 16 wherein a number of the plurality of light pulses is in a range of 10,000-200,000.

19. The method of claim 16 wherein a number of the plurality of light pulses is chosen to result in a reproducible mass spectrum.

20. The method of claim 16 wherein a number of the plurality of light pulses is chosen to reduce noise in the mass spectrum.

21. The method of claim 14 wherein the one or more analytes of interest comprises a biomarker.

22. The method of claim 14 wherein the bodily fluid comprising the one or more analyte of interest comprises at least one of blood, blood serum, blood plasma, blood platelets, ascites fluid, breast milk, cerebrospinal fluid, lymph, fluid, saliva, urine, gastric and digestive fluid, tears, stool, semen, semen-derived fluids, such as aspermic semen, prostatic fluid, vaginal fluid, amniotic fluid, and, interstitial fluids derived from tissue or tissue biopsies.

23. The method of claim 14 wherein the collecting of the sample of the bodily fluid comprises at least one of lancing, needle withdrawal, and pipetting.

24. The method of claim 14 wherein the preparing of the sample of the bodily fluid suitable for analysis by MALDI-TOF mass spectrometry comprises performing at least one of dilution, separation, concentration by drying, evaporation, centrifugation, sedimentation, precipitation, differential mobility or retention, amplification, ion exchange and antibody capture.

25. A method of Matrix-Assisted Laser Desorption/Ionization Time-of-Flight (MALDI-TOF) mass spectrometry for assaying glycated hemoglobin in blood, the method comprising:
a) collecting a sample of blood from a subject;
b) diluting the sample of blood in a solution containing a UV absorbing MALDI matrix;
c) transferring the diluted sample to a sample plate;
d) transferring the sample plate to a vacuum chamber for MALDI TOF mass spectrometry;
e) ionizing the diluted sample and the UV absorbing MALDI matrix on the sample plate with a laser generating a plurality of light pulses;
f) generating a mass spectrum from the ionized diluted sample and the UV absorbing MALDI matrix; and
g) quantitatively determining from the mass spectrum a ratio of an intensity of a glycated hemoglobin ion to an intensity of a corresponding unglycated hemoglobin ion.

26. The method of claim 25 further comprising scanning the plurality of light pulses across a predetermined area of the diluted sample and the UV absorbing MALDI matrix.

27. The method of claim 25 wherein the ionizing the diluted sample and the UV absorbing MALDI matrix on the sample plate with the laser comprises irradiating a spot on the sample with the plurality of light pulses.

28. The method of claim 27 wherein a number of the plurality of light pulses is greater than 10,000.

29. The method of claim 27 wherein a number of the plurality of light pulses is in a range of 10,000-200,000.

30. The method of claim 27 wherein a number of the plurality of light pulses is chosen to result in a reproducible mass spectrum.

31. The method of claim 27 wherein a number of the plurality of light pulses is chosen to reduce noise in the mass spectrum.

32. The method of claim 25 wherein the collecting the sample of blood from the subject comprises collecting a single droplet of whole blood from the subject withdrawn by a finger stick using a lancet.

33. The method of claim 32 wherein the collecting the single droplet of whole blood from the subject is performed by the subject.
